(19) United States
(12) Patent Application Publication
(10) Pub. No.: US 2015/0064641 A1
(43) Pub. Date: Mar. 5, 2015

(54) INDIRECT BONDING TRAYS AND METHODS OF MAKING AND USING THE SAME

(71) Applicant: Steven N. Gardner, Lehi, UT (US)

(72) Inventor: Steven N. Gardner, Lehi, UT (US)

(21) Appl. No.: 14/136,374

(22) Filed: Dec. 20, 2013

Related U.S. Application Data
(60) Provisional application No. 61/871,796, filed on Aug. 29, 2013.

(51) Int. Cl. A61C 7/14; A61C 9/00; G06F 17/50; A61C 7/00

(52) U.S. Cl. CPC A61C 7/146; A61C 7/002; A61C 9/004; G06F 17/50
USPC 433/3; 433/24; 433/29; 700/98

(57) ABSTRACT

Indirect bonding trays and methods for making and using the same may include an indirect bonding tray which is created by use of a three-dimensional printer or similar functioning device. The indirect bonding trays may include flex hinges or tear-away areas for facilitating removal from a set of teeth. The method of making the indirect bonding tray may include obtaining a digital representation of the teeth; placing one or more digital brackets on the teeth and printing or otherwise forming an indirect bonding tray based on the digital representational of the teeth and digital brackets.

### BACKGROUND

1. State of the Art

Some aspects of the present invention(s) relate to indirect bonding trays and methods for making and using the same. Other aspects of the present invention(s) relate to a method for digitally placing brackets on teeth to obtain desired bracket location.

2. Field of Art

During orthodontia, a patient's teeth are straightened or otherwise reoriented in order to provide a more pleasing smile and to correct a variety of bite misalignments which can damage teeth, interfere with the ability to chew properly, and interfere with proper jaw alignment. In order to properly align the teeth, it is common to adhesively attach a bracket to each tooth which is to be moved. The brackets are then connected to one another by one or more wires which are formed to apply gentle pressure to each tooth and gradually move each tooth in to a desired location and orientation.

One problem with the brackets is that they are time consuming to place. In order to obtain the desired movement of the teeth, an orthodontist will place the bracket in a particular place and orientation which may vary for each tooth. Once the bracket is placed on the tooth, an adhesive is cured with an ultraviolet light so that the bracket holds firmly in the correct location. The more accurate the placement of the bracket on the tooth, the more likely that the desired repositioning will occur.

Traditionally, the placement of the brackets has been done by hand with each bracket being positioned in place by the orthodontist and either the orthodontist or an assistant applying the UV light to cure the adhesive. This is a laborious process that can take an hour or more for each of the upper and lower sets of teeth.

Because of the time consumed in placement of the brackets on the teeth, many orthodontists have transitioned to indirect bonding. In indirect bonding, a mold is made of the patient's mouth. A casting of the patient's mouth is then made. The brackets are then attached to the casting in their desired location with a temporary adhesive. The attachment of the brackets to the casting may be done by the orthodontist (in a controlled environment in which placement is easier than in a patient's mount) or by a technician who places the brackets on a casting based on instructions from the orthodontist. There is currently software which allows an orthodontist to graphically or digitally place the brackets, with the actual placement carried out by a remote technician. The software may include a digitized scan of the patient's casting, or can use a digital scan of the patient's mouth.

Once the brackets are placed on the casting, a tray is vacuum formed over the brackets and the brackets are released from the casting. The tray containing the brackets can have adhesive applied to the brackets and then be placed in the patient's mouth. Once in the patient's mouth, UV light is used to cure the adhesive and bond the brackets to the patient's teeth. Overall this is a less demanding way of attaching the brackets to the teeth than the orthodontist manually placing each bracket on the patient's teeth.

While the use of indirect bonding trays is advantageous, they present a dilemma. If the tray carrying the brackets is too soft or flexible, the placement of some or all of the brackets on the teeth is not accurate and the orthodontist may have to break off and reattach some of the brackets to the teeth. This adds time to the process and can be uncomfortable for the patient.

In contrast, if the indirect bonding tray is too hard or rigid, the bonding has very little flex and the tray will not release from the brackets. This is problematic because while the more rigid tray provides better positioning, the more rigid tray is also more difficult to get off the brackets and out of the patient's mouth.

In an attempt to overcome these issues, a common method for indirect bonding currently used uses a two-step process. First, a more flexible tray is vacuum formed over the casting and brackets. Then a more rigid tray is formed over the more flexible tray. While the rigid tray provides support to the flexible tray, the brackets are still able to move and may require repositioning.

Thus, there is a need for an improved indirect bonding tray and method of making and using the same.

### SUMMARY OF THE INVENTION

In accordance with one aspect of the present disclosure, an indirect bonding tray of the present invention may include a tray body which will hold the brackets for application to a patient's teeth.

In accordance with one aspect of the disclosure, the indirect bonding tray may be made from a first material having a first rigidity and a second material having a second rigidity which is flexible, or less rigid than the first material.

In accordance with another aspect of the disclosure, the more rigid material is used in locations wherein the indirect bonding tray holds the brackets for attachment to the teeth such that the brackets are less able to change orientation or location while the indirect bonding tray is being placed in the mouth and while the adhesive is being cured.

In accordance with another aspect of the disclosure, the less rigid material is used at various locations in the indirect bonding tray which will allow sections of the more rigid material to pivot with respect to one another to allow the bonding tray to disengage from the brackets and to be removed from the mouth of the patient more easily. Thus, the less rigid or flexible material may form a flex hinge within the indirect bonding tray.

In accordance with one aspect of the disclosure, the less rigid material is used along a seam on the bottom of the indirect bonding tray to allow inner and outer portions of the tray to flex away from each other after the brackets have been bonded to the teeth to facilitate removal of the bonding tray.

In accordance with still yet another aspect of the disclosure, the less rigid material may be used at locations between the imprint of various teeth to facilitate removal of the tray from the teeth.

In accordance with still another aspect of the disclosure, the less rigid material may be sufficiently soft that it may be torn to remove portions of the indirect bonding tray from a tooth once the bracket is attached, or to provide access to the tooth while the tray is still in place to enable an orthodontist to check on a bracket or to place a brace manually if desired.

In accordance with still another aspect of the disclosure, the indirect bonding tray is formed by three-dimensional (3-D) printing rather than being vacuum formed over a casting having brackets temporarily attached thereto.

The present disclosure also includes methods for forming an indirect bonding tray and for the use of the same. For example, in accordance with one aspect of the invention, the indirect bonding tray may be formed by 3-D printing and the brackets may be placed in the bonding tray independent of a casting.

Another aspect of the invention involves using a digital model of the patient's teeth to calculate desired dimensions of the indirect boding tray.

Another aspect of the disclosure includes computer software or the like which is programmed to allow a user to graphically place digital brackets on a digital model or replication of a patient's teeth and thereby obtain very precise location and orientation control over a bracket's location when applied to a tooth.

Another aspect of the disclosure may include computer software or the like which allows the orthodontist or other user to select how much of the indirect bonding tray will engage each bracket to thereby provide improved control over holding the bracket while allowing the bracket to be easily removed from the tray once it has been attached to the patient's tooth.

In accordance with an aspect of the present disclosure, once the orthodontist has completed the digital placement of the digital brackets, and adjusted the amount of engagement desired between the indirect bonding tray and a bracket, an indirect bonding tray may be printed by a three-dimensional printer or other three-dimensional formation technique (such as three-dimensional curing in a resin bath, etc.). A technician may then place the desired physical brackets in appropriate bracket boxes or receptacles in the tray which are designed to hold the brackets in the specific location and orientation desired by the orthodontist. The tray can then be transported to the orthodontist for placement in the patient's mouth to attach the brackets to the patient's teeth.

These and other aspects of the present invention are realized in an indirect bonding tray and methods of making and using the same as shown and described in the following figures and related description. It will be appreciated that various embodiments of the invention may not include each aspect set forth above and aspects discussed above shall not be read into the claims unless specifically set forth therein.

### BRIEF DESCRIPTION OF THE DRAWINGS

Various embodiments of the present disclosure are shown and described in reference to the numbered drawings wherein:

FIG. 1 shows a perspective view of a digital representation of a patient's teeth;

FIG. 2 shows a side view of the upper set of teeth with a digital image of a bracket being disposed thereon;

FIG. 2A shows a close-up of the plan view of the teeth shown in FIG. 2;

FIG. 2B shows a close-up of the control panel shown in FIG. 2;

FIG. 3 a shows side view of the upper set of teeth with brackets on a plurality of the teeth;

FIG. 4 shows a side view similar to FIG. 2 with a bracket box having a determined amount of surface area engaging the bracket;

FIG. 5 shows a perspective view showing a plurality of the brackets having bracket boxes;

FIG. 6 shows a front view of the upper teeth as a user sets the height of the indirect bonding tray;

FIG. 7 shows a digital representation of the inner layer of an indirect bonding tray;

FIG. 8 shows a digital representation of an indirect bonding tray based on the locations of the brackets shown in FIG. 3;

FIG. 9 shows an indirect bonding tray in accordance with the present disclosure having a plurality of brackets disposed therein;

FIG. 10 shows an indirect bonding tray in accordance with the present disclosure having flex hinges formed into the indirect boding tray;

FIG. 11 shows a photograph of an indirect bonding tray having the tray material torn to release one of the bracket boxes; and

FIG. 12 shows a system for producing indirect bonding trays in accordance with the present disclosure.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the present disclosure in a single figure, and as such, multiple figures are presented to separately illustrate the various details of different aspects of the invention in greater clarity. Similarly, not all configurations or embodiments described herein or covered by the appended claims will include all of the aspects of the present disclosure as discussed above.

### DETAILED DESCRIPTION

Various aspects of the invention and accompanying drawings will now be discussed in reference to the numerals provided therein so as to enable one skilled in the art to practice the present invention. The skilled artisan will understand, however, that the methods described below can be practiced without employing these specific details, or that they can be used for purposes other than those described herein. Indeed, they can be modified and can be used in conjunction with products and techniques known to those of skill in the art in light of the present disclosure. The drawings and the descriptions thereof are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Reference in the specification to “one embodiment,” “one configuration,” “an embodiment,” “a configuration” or similar terminology means that a particular feature, structure, or characteristic described in connection with the embodiment may be included in at least one embodiment, etc. The appearances of the phrase “in one embodiment” in various places may not necessarily limit the inclusion of a particular element of the invention to a single embodiment, rather the element may be included in other or all embodiments discussed herein.

Furthermore, the described features, structures, or characteristics of embodiments of the present disclosure may be combined in any suitable manner in one or more embodiments. In the following description, numerous specific details may be provided, such as examples of products or manufacturing techniques that may be used, to provide a thorough understanding of embodiments of the invention. One skilled in the relevant art will recognize, however, that embodiments discussed in the disclosure may be practiced without one or more of the specific details, or with other methods, components, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein, but is extended to include equivalents thereof as would be recognized by those of ordinarily skill in the relevant art. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such aspect is required to be present apart from an express inclusion of that aspect in the claims.

It should also be noted that, as used in this specification and the appended claims, singular forms such as “a,” “an,” and “the” mean at least one and may include the plural unless the context clearly dictates otherwise. Thus, for example, reference to “a bracket” may include an embodiment having one or more of such brackets, and reference to “the layer” may include reference to one or more of such layers.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing the nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

Distal and proximal, as used herein, are from the perspective of the person using the indirect bonding tray or the software interface described herein, with distal meaning toward the patient and proximal meaning toward the orthodontist, technician, etc.

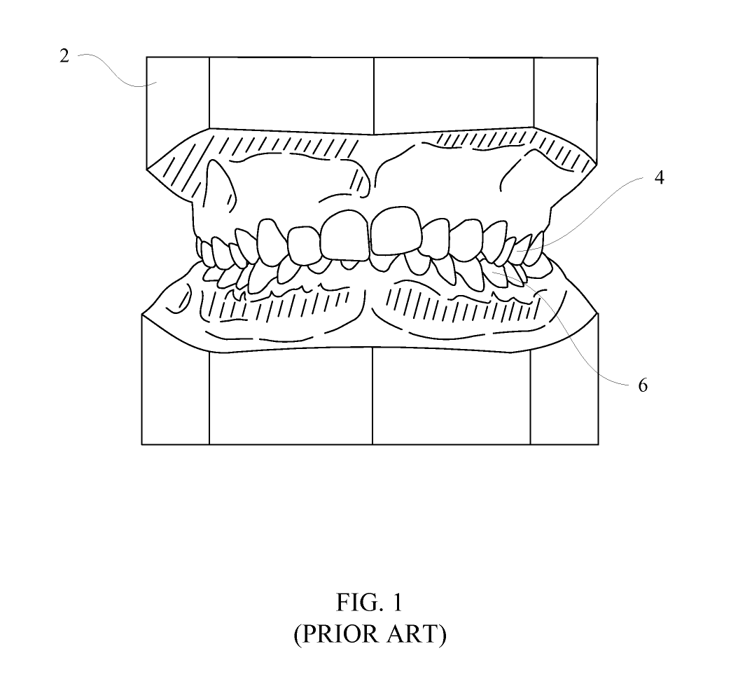

Turning now to FIG. 1, there is shown a perspective view of a representation of a patient's teeth 2. Both an upper set 4 of teeth and a lower set of teeth 6 are shown. It is also apparent that the teeth are misaligned, thereby providing a need for orthodontia.

It will be appreciated that representation may be a casting made from a mold of a patient's teeth, though a digital rendition would look substantially similar and it is becoming increasingly common for orthodontists and the like to keep the case study model of each patient digitally, as the castings take up considerable space when held for a large number of patients. The digital representation can be based on a three-dimensional digital image or model of the casting, or a three-dimensional digital image may be taken of the patient's mouth to form a computer model, thereby avoiding the need for a casting.

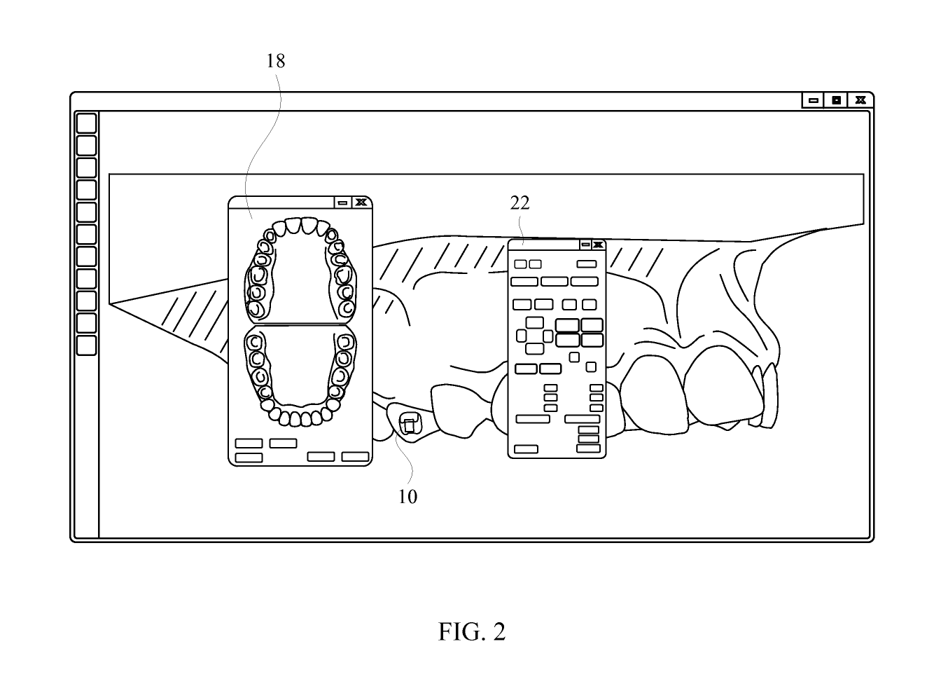

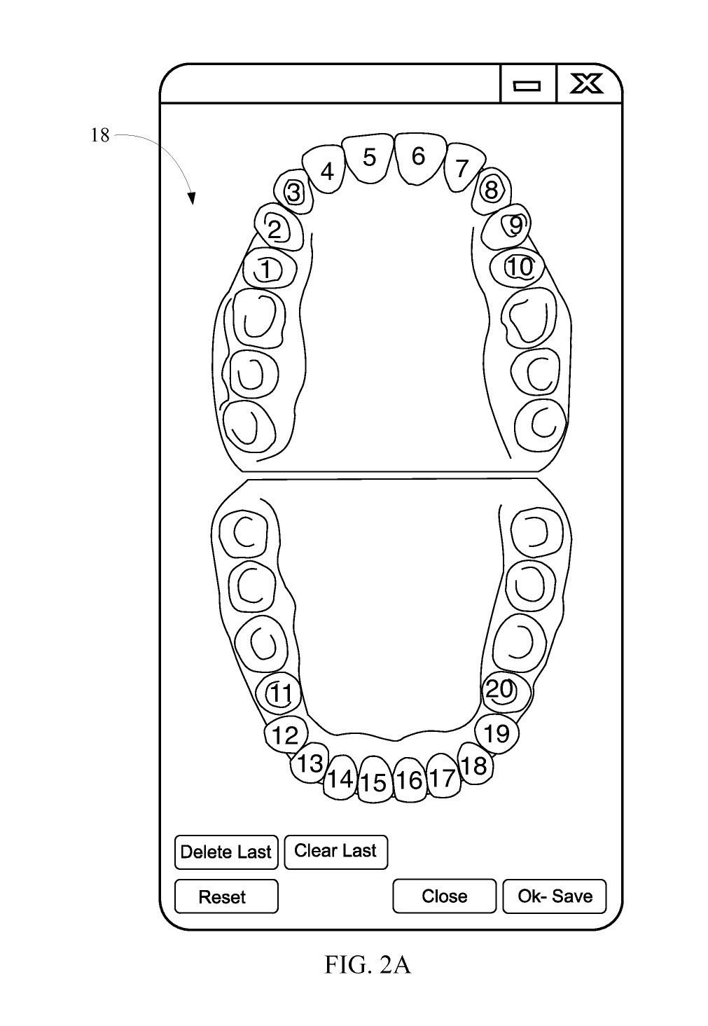

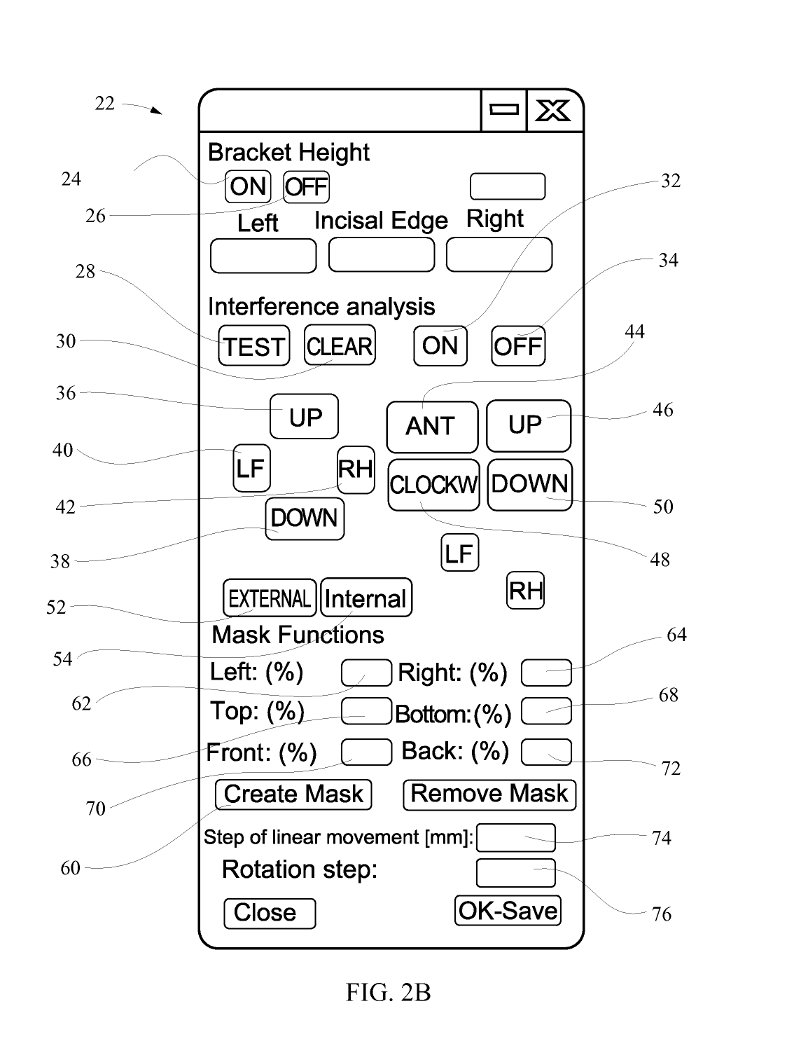

FIG. 2 shows a side view of the upper set of teeth 4 with a digital model of a bracket (or digital bracket 10) being disposed thereon. Unlike a casting on which an actual bracket is placed by the orthodontist, etc., the user can select a desired size/configuration of a digital bracket 10 and digitally place it on the tooth in the model in a desired location and at a desired orientation. Thus, for example, the orthodontist can move the bracket up or down, right or left, and rotate the digital bracket forward or backward depending on the change in tooth positioning that needs to occur.

One advantage of the digital image or model shown in FIG. 2 is that numerous pieces of information can be made available to the orthodontist while he or she is positioning the digital bracket. For example, to the left of FIG. 2 is a map 18 of the teeth with each tooth numbered (shown in the close-up image of FIG. 2A). If the orthodontist is dictating notes while he or she is placing the digital brackets 10, the exact number of the tooth being worked on is readily identifiable.

Also shown in FIG. 2 is graphical control panel 22 which can be used to control the positioning of the digital bracket as shown in the boxes in the upper portion of the control box. (A close-up of the control panel 22 with detailed numbering is shown in FIG. 2B). Thus, for example, there may be icons or buttons 24, 26, 28, 30, 32, 34, 36, 38, 40, 42, 44, 46, 48 and 50 which allow control of digital bracket height (24—on, 26—off (input boxes may also be included), interference analysis (28, 30), control the cursor (on 32, off 34), control movement of the digital bracket 10 up (36), down (38), left (40), right (42), as well as rotation anterior (44), up (46), clockwise (48), down (50). The control box 22 can also has buttons 52, 54 to control external (52) and internal (54) views. This allows the orthodontist, etc. to carefully place the digital bracket 10 in a desired location without having to do so in the patient's mouth.

The control box 22 may also provide mask functions 60 (i.e. creating the inner wall of an indirect bonding tray). As was mentioned above, one aspect of the present invention is that a casting is not necessary. Instead of placing brackets on a casting and then vacuum-forming a tray over the brackets, one aspect of the present disclosure may include forming a formed physical indirect bonding tray which will receive physical brackets. It is important that the brackets be securely held in the proper place in the tray. However, the more securely the bracket is held for placement, the more difficult it is for the tray to be removed from the bracket after the bracket has been bonded to the tooth.

As shown in FIGS. 2 and 2B, the mask functions allow the user to control the amount of engagement between a digital bracket box formed in a digital indirect bonding tray and digital bracket to ultimately form a bracket box formed in the physical indirect bonding tray which properly receives the bracket. For example, an orthodontist may want a particular bracket held very securely in the tray. By using the mask functions, she can increase the percentages of surface area by input boxes for left (62) right (64), top (66), bottom (68), frontside (70) and backside (72) of the digital bracket (and ultimately the physical bracket) which will be engaged by the bracket boxes formed into the indirect bonding tray. (It will be appreciated as used herein the term bracket box is used to identify any receptacle or other formation in the indirect bonding tray which is intended to receive and hold a bracket. The bracket box will typically engage several sides of the bracket but will not be a complete enclosure, as the bracket will be bonded to the tooth and pulled out of the bracket box. Thus, the term bracket box and bracket receptacle may be used interchangeably).

The control box 22 can also provide data entry boxes for step of linear movement (74) and rotation step (76). Thus, the orthodontist is allowed very specific control both of the location and orientation of each bracket, but also how each physical bracket will be engaged and held by the walls forming the physical bracket box in the physical indirect bonding tray.

In FIG. 2, the marking has been done with a 15 percent engagement on the right and left sides. Depending on the height of the digital bracket and the depth of the digital indirect bonding tray, the top of the bracket may be even with, or extend above, the tray. Thus, in FIG. 2, the top engagement is set at zero. The bottom engagement is set at 10 percent and the front side is set at 10 percent. The backside is set at 15 percent which will cause the ends of the bracket box to extend around the bracket sufficiently to engage the tooth to which the bracket is to be bonded. It will be appreciated that the settings for each tooth may be different and the percentages identified above are only one example.

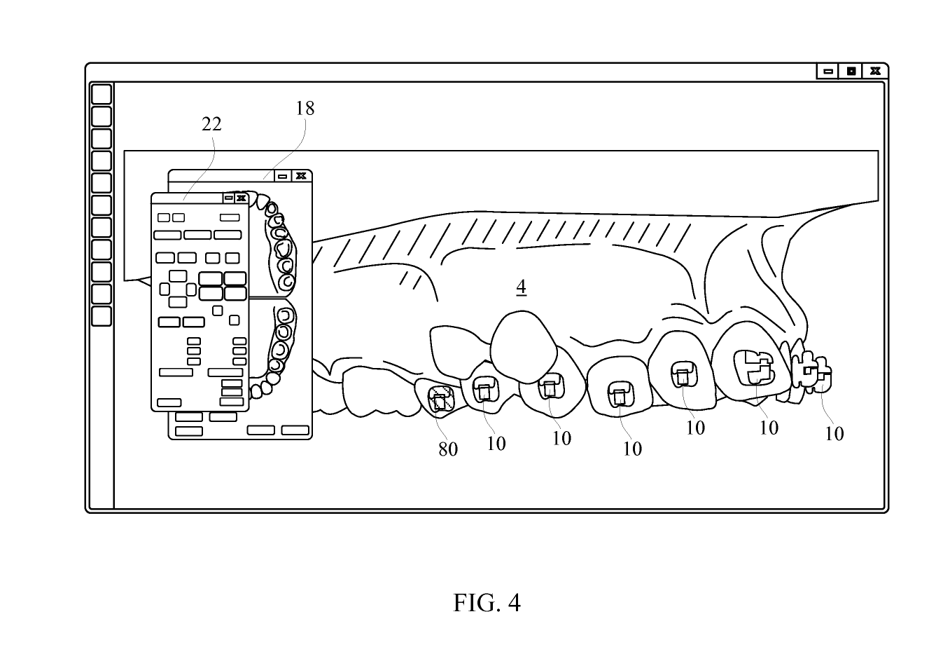

Once the mask functions are entered into the software, a digital bracket box 80 (FIG. 4) or bracket receptacle can be created in an indirect bonding tray which is formed by three-dimensional printing. The digital bracket box 80 can be formed so that the chosen physical brackets can snap into the bracket boxes in the physical indirect bonding tray sufficiently to be held in the proper place during adhesion to the tooth, but not so tightly that the indirect bonding tray cannot be removed by the orthodontist after the bracket 10 is attached to the tooth. The mask function allows the orthodontist to customize the digital bracket box (and thus the bracket box in the physical tray) to his or her personal preferences.

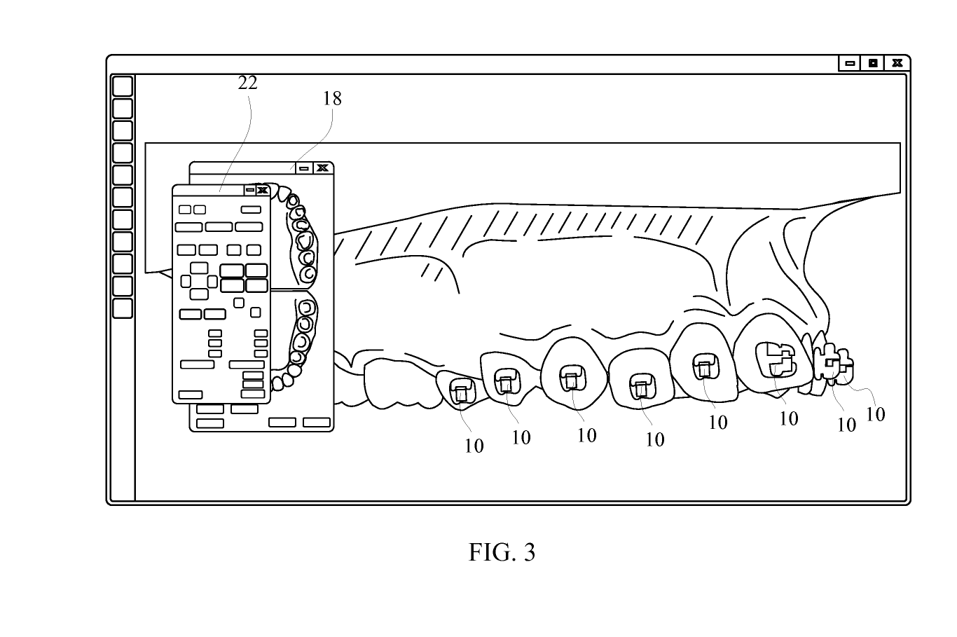

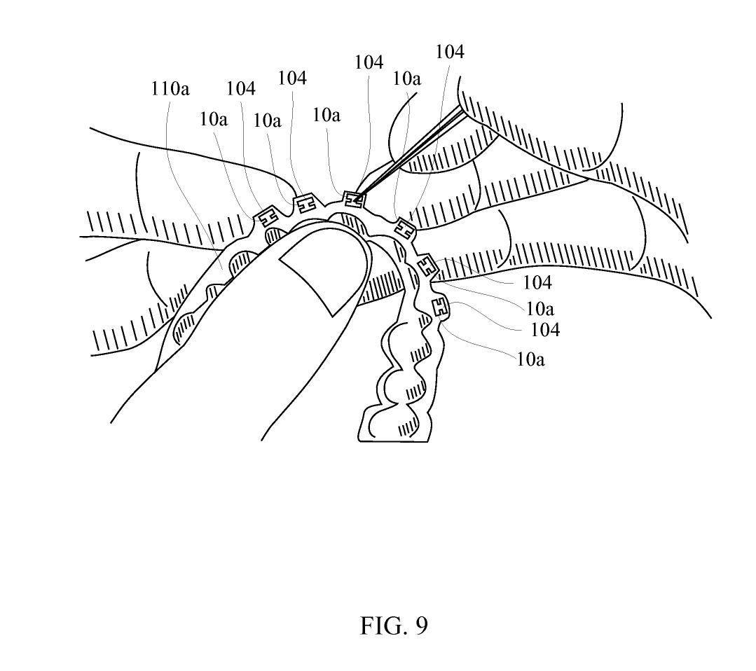

Turning now to FIG. 3, there is shown a view of a monitor with a close-up side view of the upper set of teeth 4 of the digital model 2 with digital brackets 10 on a plurality of the teeth. Each of the digital brackets 10 has been placed to effect the desired change in tooth position when orthodontia is completed. As the user goes through the process of placing the digital brackets, the mask functions may be used for each digital bracket 10 to define the desired bracket box for that particular bracket. Ideally, the physical bracket 10a (FIGS. 9-11) will lightly snap into the bracket box formed in the physical indirect bonding tray so it is held securely during placement, but not so tight that the bracket is difficult to pull out of the bracket box.

FIG. 4 shows a side view similar to FIG. 2 with a digital representation of a digital bracket box 80 formed over the bracket (not show). As still shown in the control panel 22, the amounts of engagement between the digital bracket box inner wall and the exterior of the bracket have been selected by the orthodontist (or by a technician if desired). The digital bracket box 80 may extend beyond the bracket in areas where it is not desired to engage the bracket.

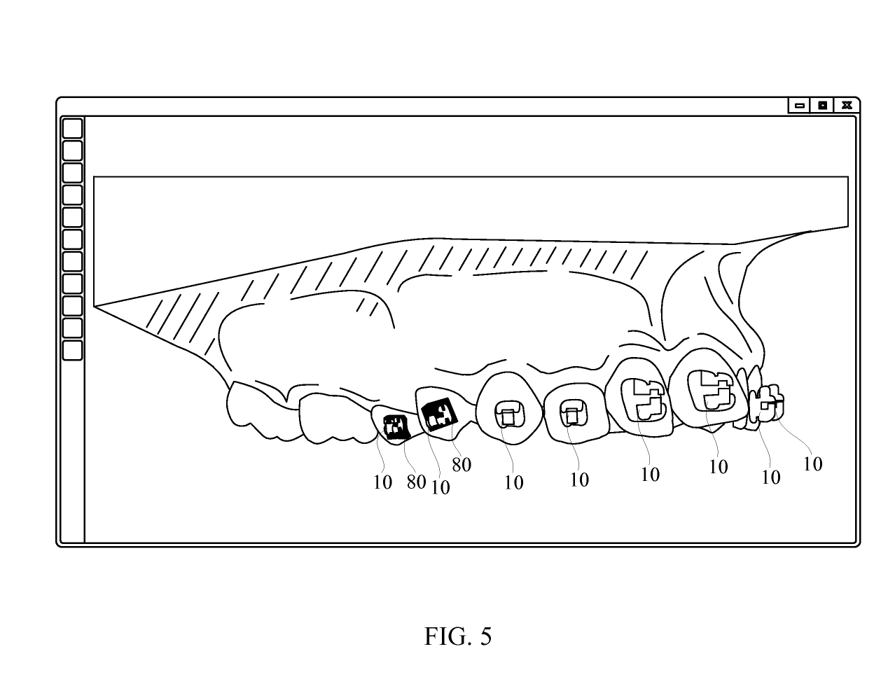

FIG. 5 shows a monitor with a side view of a model of the teeth similar to FIG. 3. The rearward two teeth each have a black box formed about the bracket. The black in FIG. 5 represents voids in the ultimate physical indirect bonding tray which would be partially filled by brackets 10a. The portions of the digital brackets which are visible (lighter shading) show exterior surfaces of the brackets which may engage the walls defining the bracket boxes or receptacles.

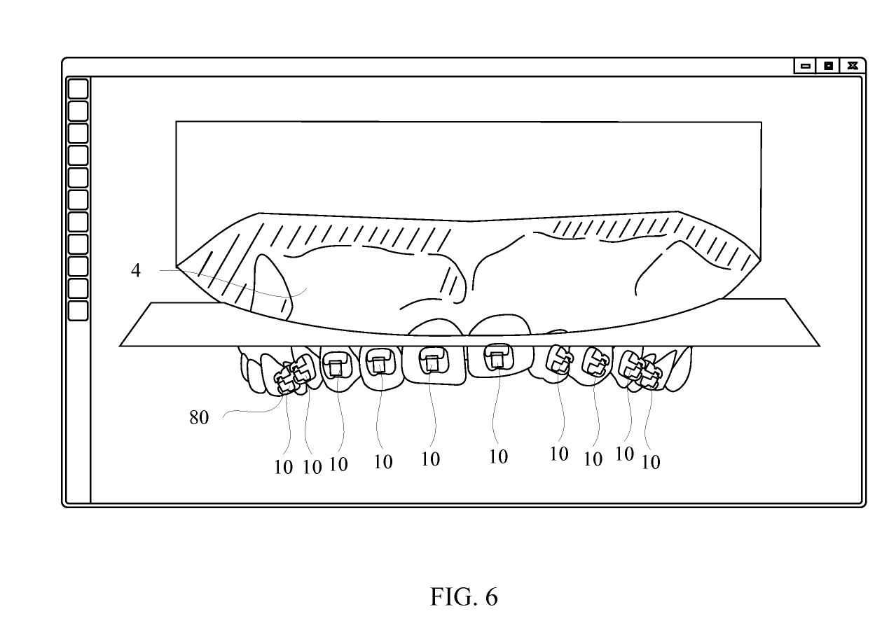

Turning now to FIG. 6, there is shown a front view of the upper teeth 4 as a user sets the height of the digital indirect bonding tray as represented by the black plane. It will be appreciated that due to the misalignment of teeth, there may be situations where the top of some brackets 10a actually extend above a completed tray and the top of other brackets may be below the top of the tray. The control panel 22 allows the user to control for such by allowing him or her to have a range from 0 to a substantial percentage of the surface area at the top of the bracket being engaged by the indirect bonding tray. While the top of the indirect boding tray may be planar, it can also be customized for each tooth.

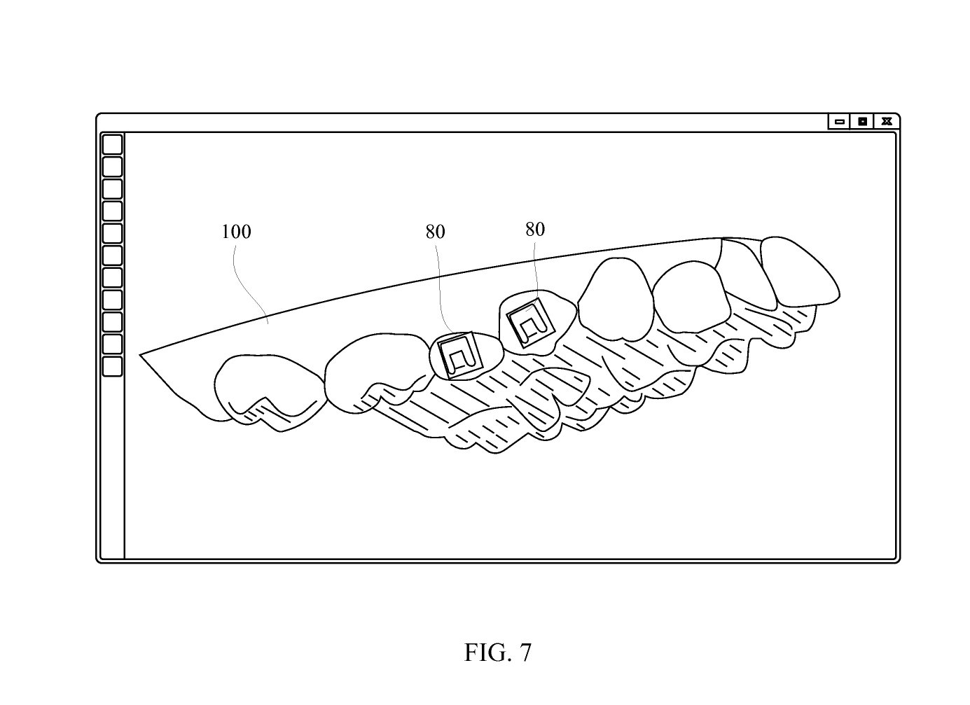

FIG. 7 shows a mask 100 based on the information entered into the control panel 22. As only two digital bracket boxes 80 were entered in for the digital brackets 10 as shown in FIG. 5, only two digital bracket boxes or receptacles 80 are shown in FIG. 7. It will be appreciated that a normal mask 100 would ordinarily have a bracket box 80 for each bracket to be used on the upper or lower teeth.

The mask 100 as shown in FIG. 7 is razor thin and merely represents the inner surface of the physical indirect bonding tray as it would exist once built up in three-dimensional printing. However, the view of the mask 100 provides a good view of the digital bracket boxes 80 which are less visible in the indirect bonding tray because of the thickness of the tray.

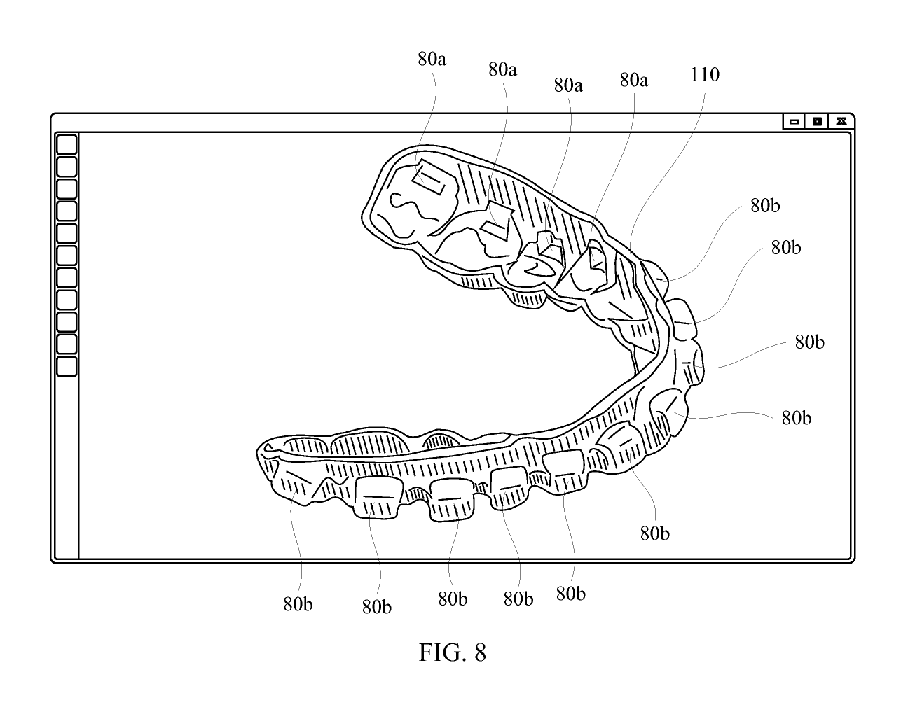

Turning now to FIG. 8, there is shown a three-dimensional digital indirect bonding tray 110 based on the locations of the brackets (such as are shown in FIG. 3). As will be apparent, digital indirect bonding tray 110 has digital bracket boxes or receptacles 80 for a full set of upper teeth.

The interior 80a of the digital bracket boxes 80 are designed so that a physical replication thereof will securely receive the brackets to hold the brackets in place. The exterior 80b does not need to have any detail thereto. As was mentioned previously, the indirect bonding tray can be formed low enough that most or all of the brackets are at or extend above the upper surface. In the alternative, some or all of the brackets can be disposed to that the upper surface thereof is positioned below the top of the boding tray as shown in FIG. 8.

The digital indirect bonding tray 110 and the physical replica that will be made therefrom is different than the prior art in that it is not formed by vacuum forming the plastic over the brackets. To the contrary, a physical indirect bonding tray 110a is formed by three-dimensionally printing the tray based on the dimensions shown in the digital representation in the software (or by some other three-dimensional formation technique such as curing a resin bath). Thus, rather than temporarily attaching brackets to a casting and then forming the indirect boding tray over the brackets and releasing the brackets from the casting, the indirect bonding tray 110a (FIGS. 9-11) is printed and then the brackets 10 (FIGS. 2-5) are placed in the bracket boxes or receptacles 104 formed by the 3-dimensional printer.

The portion of the physical indirect bonding tray 110a which forms the bracket boxes 104 (FIGS. 9-11) is preferably a substantially rigid plastic material. For example, a plastic with a Shore A rating above about 70 (such as VEROCLEAR-RGD810 with a Shore A rating of 95—Available from Stratasys in Billerica, Mass.) could be used. A more desirable range may be a Shore A rating between about 85 and 100. Thus, a first portion of the physical indirect bonding trade is made from a material having a first rigidity. Additionally, a second (or additional) portion of the physical indirect bonding tray may be made of a more flexible plastic or rubber material having a Shore A rating below 70. A more desirable range for the more flexible portion may be between 20 and 40, such as TANGOBLACK FLX973 (available from Statasys in Billerica, Mass.) with a Shore A rating of 27. It will be appreciated that there is a large number of materials which can be digitally printed and the claims are intended to cover such materials.

This prevents the location of the bracket from being changed during placement on the teeth. While the use of hard plastics in the past has led to difficulty in removing the indirect bonding trays of the prior art, the physical indirect bonding tray 110a of the present invention resolves this problem.

FIG. 9 shows a physical indirect bonding tray 110 in accordance with the present disclosure with a plurality of brackets 10 disposed in the bracket boxes or receptacles 104 therein. As mentioned above, one advantage of the present invention is that it does not require vacuum forming or use of a casting. Rather, the indirect bonding tray 110a is printed using a three-dimensional printer according the specifications determined by digitally placing a digital construction of a bracket on the digital representation of the patient's teeth and determining the extent to which the physical indirect bonding tray will engage each bracket 10a placed into a bracket box 104.

One advantage of the present invention is that the orthodontist does not need to have any specialized equipment other than his or her computer. He or she may place the brackets 10a digitally on the image of the teeth 2 and select the amount of engagement he or she desires between the brackets and the physical indirect bonding tray 110a. With that information, a remote lab can print the physical indirect bonding tray 110a and insert the brackets 10a in the bracket boxes 104. Once the loaded indirect bonding trays 110a arrive, the orthodontist (or a technician) needs only apply a bonding agent, insert the indirect bonding tray over the patient's teeth and then use a UV light applicator to bond the brackets 10a to the teeth.

As was mentioned above, it is desirable that the area of the physical indirect bonding trays 110a which form the bracket boxes 104 being relatively rigid (i.e. a Shore A above 70, and preferably above 85) so that the brackets 10a do not move. Making a rigid indirect bonding tray would be problematic in the prior art because once the brackets have been bonded to the teeth, it would be very difficult to the remove the indirect bonding tray from the brackets and thus the teeth.

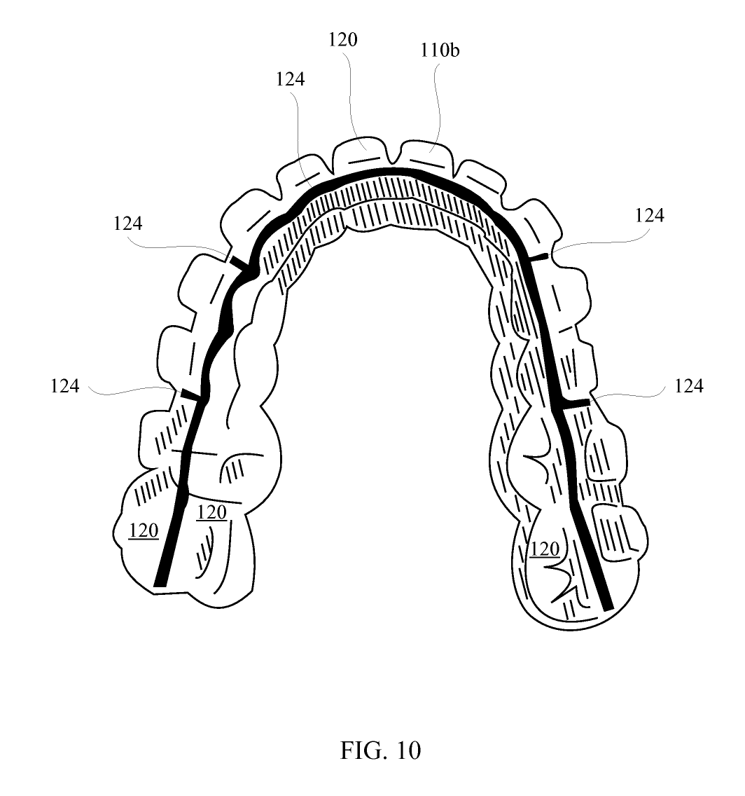

The present disclosure resolves such concerns with the embodiment of a physical indirect bonding tray 110a shown in FIG. 10. Rather than the entire indirect bonding tray 110b being made from a single material, the indirect bonding tray of FIG. 10 includes a first material, 120 and a second material 124. The first material 120 is substantially rigid and holds the brackets firmly. The second material 124 relatively flexible (i.e. a Shore rating below 70 and typically 20-40) and is laid down during formation to form a plurality of hinge joints 128 about which the portions of rigid material 120 can pivot and bend away from each other. For example, the first material 120 may be VEROCLEAR-RGD810 and the second material 124 may be TANGOBLACK FLX973. It will be appreciated that a wide variety of different plastics and other materials can be used.

The flexibility of the second material 124 allows, for example, part 120a to be pivoted away from part 120b, thereby allowing the indirect bonding tray 110b to be removed from off the bonded brackets. It will be appreciated that a single hinge 128 can be formed so as to bisect the indirect bonding tray 110b along the centerline of the teeth. Additionally, a plurality of hinges 128 may be placed between individual teeth or groups of teeth to further facilitate removal.

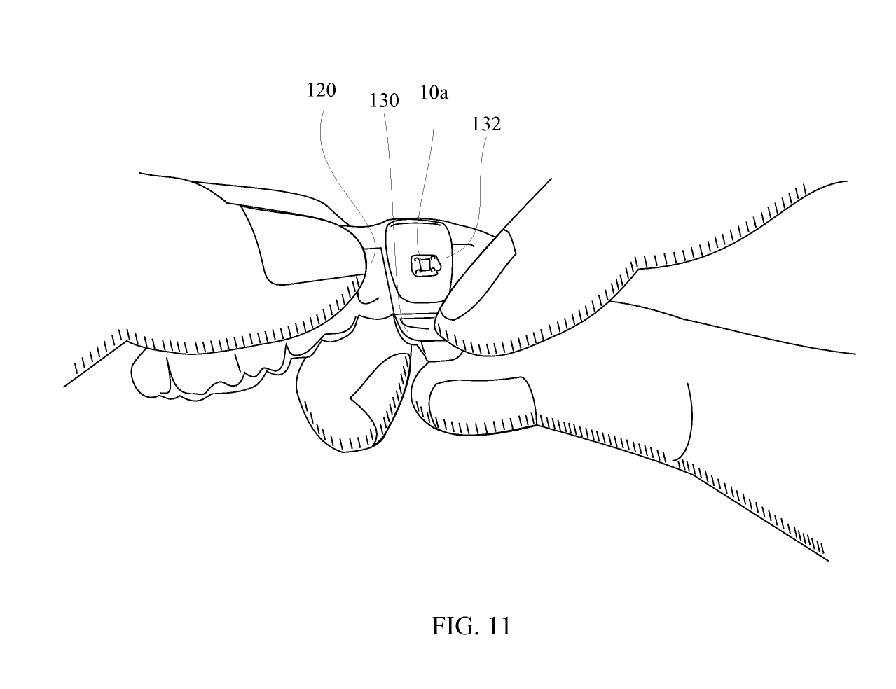

While the second material may simply be flexible, the second material 124 may also be sufficiently soft or weak that it can be torn. Thus, FIG. 11 shows a piece of rigid material 120 which has been torn along two seems 130 formed by the second material 124 to expose a tooth 132 having a physical bracket 10a bonded thereto. This allows an orthodontist to cure the bonding material with a UV light applicator and then tear way portions of the indirect bonding tray 110a to provide access to teeth, etc. Thus, the orthodontist can check any tooth he or she is concerned about without having to remove the whole tray from the patient's mouth.

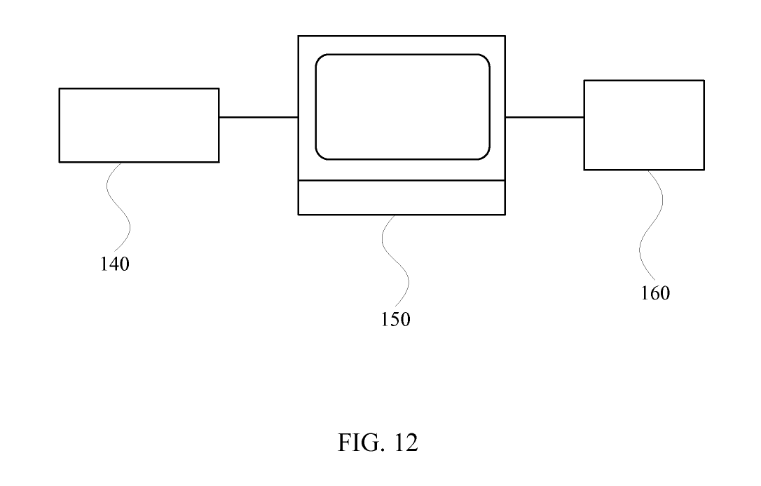

Turning now to FIG. 12, there is shown a system for making indirect bonding trays in accordance with the present disclosure. The system includes an imaging apparatus 140 for developing a three-dimensional digital model of the teeth of a person or other mammal. The imaging apparatus 140 may be any of a variety of known devices which allow a three-dimensional digital model of teeth to be made. Additionally, it will be appreciated that on imaging apparatus 140 may scan a person or animals mouth directly, while another may be configured to scan existing castings of teeth.

The scanner 140 is disposed in communication with a processor, such as a computer 130 with a monitor and display screen through which the steps of placing the digital brackets and forming the digital bracket boxes may be performed. The manner in which the two are disposed in communication need not be limited, but may include direct connection, wireless connection, BLUETOOTH, or may simply be configured for read and write to a common medium such as a disk drive or flash memory.

The computer 150 preferably includes computer code or the like disposed thereon which allows for a visible digital three-dimensional model of the teeth (although a two dimensional model could be used). The computer code also preferably includes code which creates a digital simulation of a bracket which would be placed on a tooth by an orthodontist using braces to realign the teeth.

Additionally, the computer code also may include code which allows a user to create a digital bracket box which is configured to receive the bracket. The code may also allow the user to control the amount of surface area at which the digital bracket and the digital bracket box would engage one another.

Furthermore, the computer may include code which allows a mask and/or a digital indirect bonding tray to be formed based on the dimensions represented by the digital bracket and the digital bonding.

The computer 150 may be disposed on communication with a three-dimensional printer 160. The computer 150 may send signals to the three-dimensional printer 160 to cause the three-dimensional printer print an indirect bonding tray. The indirect bonding tray may include a plurality of bracket boxes for receiving brackets which are to be bonded to a set of teeth.

While not required, it is preferred that the three-dimensional printer 140 be configured to be able to print two or more materials. This will allow the three-dimensional printer to print portions of the indirect bonding tray in one material, and to print a plurality of flex hinges in another material to allow the tray to be stretched or bent to facilitate removal one the brackets have been positioned.

It will be appreciated that embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

It will be appreciated from the present disclosures that multiple inventive concepts are set forth. For example, an indirect bonding tray is disclosed which may include first material and a second material and wherein the first material is less flexible than the second material. Additionally, the indirect bonding tray may be formed, wherein the second material is disposed in at least one line so as to form a flex hinge between two pieces of the first material; wherein the second material is softer than the first material so as to enable the second material to be torn to at least partially remove pieces of the first material; wherein the second material is a different color than the first material; including a plurality of bracket receptacles formed in the first material; further including a plurality of brackets which are disposed in the plurality of bracket receptacles; and/or wherein the first material is substantially rigid, or combinations thereof.

Likewise, the present disclosure relates to method of preparing braces for placement on teeth of a mammal, the method including: selecting a digital image representing the mammal's teeth which has a plurality of digital brackets disposed thereon; and forming a three-dimensional physical indirect bonding tray based on the digital image, the three-dimensional physical indirect bonding tray having at least one bracket box formed therein for holding a bracket. The method may further include: forming a three-dimensional physical bonding tray comprises using a three-dimensional printer to print the three-dimensional physical bonding tray; the selected digital image having a plurality of digital bracket boxes formed about digital brackets and wherein using the forming the three-dimensional physical indirect bonding tray includes printing a three-dimensional physical indirect bonding tray having a plurality voids forming bracket boxes for holding brackets to be applied to teeth; placing brackets into the bracket boxes form in the three-dimensional physical indirect bonding tray; printing the three-dimensional physical indirect bonding tray from a first material and a second material, the first material being more rigid than the second material such that the second material forms flex hinges between portions of the first material; and/or forming the a digital image representing the mammal's teeth which has a plurality of digital brackets disposed thereon by taking a digital image of the mammal's teeth and using a computer program to position a plurality of digital brackets at desired locations on the digital image of the mammal's teeth, or combinations thereof.

The present disclosure may also include the invention of method of creating an indirect bonding tray, the method comprising: selecting a digital image formed by a scan of at least one of a scan of a patient's mouth and a casting of the patient's mouth, the digital image including digital representations of a plurality of the patient's teeth; disposing a plurality of digital images representing brackets on the digital image so as to indicate a desired placement of brackets on the patient's teeth; and creating a physical indirect bonding tray based on the digital images representing brackets to position receptacles based on the desired placement of the brackets. The method may also include: selecting a digital bracket box which indicates a size of a desired bracket box formed in the indirect bonding tray; selecting a digital bracket box includes building a digital bracket box by controlling the amount of surface area of a bracket that will be engaged by walls in the physical indirect bonding tray which form the bracket box for holding a bracket; the physical indirect bonding tray comprises a plurality of bracket boxes and wherein the method further comprises disposing a plurality of brackets in the bracket boxes in the physical indirect bonding tray; creating the physical indirect bonding tray comprises printing the physical indirect bonding tray in a three-dimensional printer; and/or the physical indirect bonding tray comprises at least two different materials, one material being more rigid than the other material, the rigid material forming bracket boxes in the indirect bonding tray and the other material forming flex hinges between the sections of the more rigid material, or combinations thereof.

The present disclosure also includes the invention of a system for producing indirect bonding trays, the system comprising:
a scanner for generating a three-dimensional digital model of a set of teeth; a computer for receiving the three-dimensional digital model, the computer having software disposed thereon for placing digital brackets at desired locations on the set of teeth; and
a three-dimensional printer disposed in communication with the computer for printing a physical indirect bonding tray responsive to signals received from the computer. The system may also include: the software being programmed to create a control panel which allows a user to create a digital bracket box around a digital bracket; the control panel configured to allow a user to regulate the amount of surface area between the digital bracket and the digital bracket box which will engage one another; and/or the three-dimensional printer containing a first printable material and a second printable material, the first printable material being more rigid than the second printable material, or combinations thereof.

Thus there is disclosed an indirect bonding tray and methods of making and using the same. It will be appreciated that numerous modifications may be made without departing from the scope and spirit of this disclosure. The appended claims are intended to cover such modifications.

What is claimed is:

1. An indirect bonding tray comprising a first material and a second material and wherein the first material is less flexible than the second material.

2. The indirect bonding tray according to claim 1, wherein the second material is disposed in at least one line so as to form a flex hinge between two pieces of the first material.

3. The indirect bonding tray according to claim 1, wherein the second material is softer than the first material so as to enable the second material to be torn to at least partially remove pieces of the first material.

4. The indirect boding tray according to claim 1, wherein the second material is a different color than the first material.

5. The indirect bonding tray of claim 1 comprising a plurality of bracket receptacles formed in the first material.

6. The indirect bonding tray of claim 5, further comprising a plurality of brackets which are disposed in the plurality of bracket receptacles.

7. The indirect bonding tray of claim 1 wherein the first material is substantially rigid.

8. A method of preparing braces for placement on teeth of a mammal, the method comprising:
selecting a digital image representing the mammal's teeth which has a plurality of digital brackets disposed thereon; and
forming a three-dimensional physical indirect bonding tray based on the digital image, the three-dimensional physical indirect bonding tray having at least one bracket box formed therein for holding a bracket.

9. The method according to claim 8, wherein forming a three-dimensional physical bonding tray comprises using a three-dimensional printer to print the three-dimensional physical bonding tray.

10. The method according to claim 8, wherein the selected digital image has a plurality of digital bracket boxes formed about digital brackets and wherein using the forming the three-dimensional physical indirect bonding tray includes printing a three-dimensional physical indirect bonding tray having a plurality voids forming bracket boxes for holding brackets to be applied to teeth.

11. The method according to claim 10, wherein the method further comprises placing brackets into the bracket boxes form in the three-dimensional physical indirect bonding tray.

12. The method according to claim 8, wherein the method comprises printing the three-dimensional physical indirect bonding tray from a first material and a second material, the first material being more rigid than the second material such that the second material forms flex hinges between portions of the first material.

13. The method according to claim 8, wherein the method comprises forming the a digital image representing the mammal's teeth which has a plurality of digital brackets disposed thereon by taking a digital image of the mammal's teeth and using a computer program to position a plurality of digital brackets at desired locations on the digital image of the mammal's teeth.

14. A method of creating an indirect bonding tray, the method comprising:
selecting a digital image formed by a scan of at least one of a scan of a patient's mouth and a casting of the patient's mouth, the digital image including digital representations of a plurality of the patient's teeth;
disposing a plurality of digital images representing brackets on the digital image so as to indicate a desired placement of brackets on the patient's teeth; and
creating a physical indirect bonding tray based on the digital images representing brackets to position receptacles based on the desired placement of the brackets.

15. The method according to claim 14, wherein the method comprises selecting a digital bracket box which indicates a size of a desired bracket box formed in the indirect bonding tray.

16. The method according to claim 15, wherein selecting a digital bracket box includes building a digital bracket box by controlling the amount of surface area of a bracket that will be engaged by walls in the physical indirect bonding tray which form the bracket box for holding a bracket.

17. The method according to claim 14, wherein the physical indirect bonding tray comprises a plurality of bracket boxes and wherein the method further comprises disposing a plurality of brackets in the bracket boxes in the physical indirect bonding tray.

18. The method according to claim 14, wherein creating the physical indirect bonding tray comprises printing the physical indirect bonding tray in a three-dimensional printer.

19. The method according to claim 14, wherein the physical indirect bonding tray comprises at least two different materials, one material being more rigid than the other material, the rigid material forming bracket boxes in the indirect bonding tray and the other material forming flex hinges between the sections of the more rigid material.

20. A system for producing indirect bonding trays, the system comprising:
a scanner for generating a three-dimensional digital model of a set of teeth;
a computer for receiving the three-dimensional digital model, the computer having software disposed thereon for placing digital brackets at desired locations on the set of teeth; and
a three-dimensional printer disposed in communication with the computer for printing a physical indirect bonding tray responsive to signals received from the computer.

21. The system of claim 20, wherein the software is programmed to create a control panel which allows a user to create a digital bracket box around a digital bracket.

22. The system of claim 21, wherein the control panel is configured to allow a user to regulate the amount of surface area between the digital bracket and the digital bracket box which will engage one another.

23. The system of claim 20, wherein the three-dimensional printer contains a first printable material and a second printable material, the first printable material being more rigid than the second printable material.
